(19) United States
(12) Patent Application Publication
(10) Pub. No.: US 2025/0350298 A1
(43) Pub. Date: Nov. 13, 2025

(54) Adaptive Data Compression and Encryption System Using Reinforcement Learning for Pipeline Configuration

(71) Applicant: AtomBeam Technologies Inc., Moraga, CA (US)

(72) Inventors: Joshua Cooper, Columbia, SC (US); Grant Fickes, Columbia, SC (US); Charles Yeomans, Orinda, CA (US); Brian Galvin, Silverdale, WA (US)

(21) Appl. No.: 19/272,004

(22) Filed: Jul. 17, 2025

Related U.S. Application Data
(63) Continuation-in-part of application No. 19/021,202, filed on Jan. 15, 2025, now Pat. No. 12,368,453.
Application No. 19/021,202 is a continuation-in-part of application No. 18/895,409, filed on Sep. 25, 2024, now Pat. No. 12,289,121.
Application No. 18/895,409 is a continuation-in-part of application No. 18/822,203, filed on Sep. 1, 2024, now Pat. No. 12,229,679.
Application No. 18/822,203 is a continuation-in-part of application No. 18/427,716, filed on Jan. 30, 2024, now Pat. No. 12,093,972.
Application No. 18/427,716 is a continuation-in-part of application No. 18/410,980, filed on Jan. 11, 2024, now Pat. No. 12,068,761.
Application No. 18/410,980 is a continuation-in-part of application No. 18/537,728, filed on Dec. 12, 2023, now Pat. No. 12,058,333.

(51) Int. Cl. H03M 7/40; G06F 21/60; G06F 21/62; G06N 3/0455; G06N 3/092; H04L 9/00

(52) U.S. Cl. CPC H03M 7/40; G06F 21/602; G06F 21/6227; G06N 3/0455; G06N 3/092; H04L 9/008

(57) ABSTRACT

A system and method for optimizing data compression and encryption using reinforcement learning. The system analyzes incoming data streams to extract statistical features and data characteristics, which are processed by a reinforcement learning engine to automatically configure a multi-stage compression pipeline. Each compression stage transforms data into optimized distributions, applies Huffman coding, and maintains full encryption using homomorphic operations. A performance monitor tracks compression efficiency, processing speed, and output quality in real-time, providing feedback to continuously improve the reinforcement learning model's decisions. The system can dynamically adjust between one to five compression stages and select appropriate compression methods, including traditional algorithms or neural network-based approaches, based on data characteristics and performance requirements. All processing occurs on encrypted data without requiring decryption, ensuring complete data security throughout the pipeline. The adaptive nature of the system enables optimal compression performance across diverse data types while maintaining encryption integrity.

### CROSS-REFERENCE TO RELATED APPLICATIONS

Priority is claimed in the application data sheet to the following patents or patent applications, each of which is expressly incorporated herein by reference in its entirety:
Ser. No. 19/021,202
Ser. No. 18/895,409
Ser. No. 18/822,203
Ser. No. 18/427,716
Ser. No. 18/410,980
Ser. No. 18/537,728

### BACKGROUND OF THE INVENTION

### Field of the Art

The present invention relates to the field of data compression and encryption systems, and more specifically to adaptive pipeline architectures that utilize reinforcement learning to dynamically optimize multi-stage compression configurations while maintaining fully homomorphic encryption throughout all processing operations.

### Discussion of the State of the Art

Current data compression and encryption systems typically employ static, predetermined processing pipelines that apply the same compression algorithms and parameters regardless of the characteristics of the incoming data. These conventional systems implement fixed sequences of compression stages, with each stage using predefined algorithms such as Huffman coding, arithmetic coding, or dictionary-based methods. While some systems allow manual selection between different compression modes, they lack the ability to automatically adapt their configuration based on data properties or performance requirements.

Existing homomorphic encryption systems face significant challenges when combined with compression operations. Traditional approaches require data to be decrypted before compression or decompressed before encryption, creating security vulnerabilities and computational inefficiencies. Some recent systems have attempted to perform compression on encrypted data, but these implementations use rigid pipeline architectures that cannot optimize for varying data types or changing system conditions.

The fundamental problem with current approaches is their inability to dynamically balance competing objectives of compression efficiency, processing speed, encryption security, and output quality. Fixed pipeline configurations that work well for one type of data often perform poorly on others. For instance, a pipeline optimized for image compression may be inefficient for time-series data, while configurations designed for maximum compression may introduce unacceptable latency for real-time applications. Furthermore, these systems cannot learn from their performance history to improve future processing decisions.

What is needed is an intelligent system that uses reinforcement learning to automatically configure and adapt multi-stage compression pipelines based on real-time analysis of data characteristics and performance metrics, while maintaining continuous homomorphic encryption throughout all operations, enabling optimal compression performance across diverse data types without compromising security or requiring manual intervention.

### SUMMARY OF THE INVENTION

Accordingly, the inventor has conceived and reduced to practice a system and method for adaptive data compression and encryption that employs reinforcement learning to dynamically optimize multi-stage compression pipeline configurations while maintaining fully homomorphic encryption throughout all processing operations. The system analyzes incoming data streams to extract statistical features and automatically configures compression stages based on learned policies, continuously improving its performance through real-time feedback and experience replay.

In an embodiment, a computer system implements an adaptive compression and encryption pipeline using reinforcement learning. The system includes a data characterization processor that analyzes incoming data streams to extract statistical features, data type classifications, and compression ratio estimates based on entropy and redundancy patterns. A reinforcement learning policy engine with trained neural networks receives these features and outputs pipeline configuration decisions. A pipeline configuration controller dynamically constructs and reconfigures a multi-stage compression pipeline based on these decisions. The pipeline performs compression stages that include analyzing data statistics, applying transformations for improved compressibility, producing conditioned and error streams, transforming data into dyadic distributions, managing transformation matrices, performing Huffman coding, and combining encoded streams with transformation data. A performance monitor tracks compression ratios, latency, quality metrics, and resource usage to generate reward signals for training the policy engine. The reinforcement learning engine adaptively selects the number of compression stages and determines parameters based on real-time feedback, with all operations performed on encrypted data using fully homomorphic encryption.

In an aspect of an embodiment, the reinforcement learning policy engine includes a policy network that processes state vectors of at least 48 dimensions to output configuration actions, a value network that estimates performance expectations, and an experience replay buffer that stores historical decisions for continuous improvement.

In an aspect of an embodiment, the policy network determines the number of compression stages between one and five, selects between traditional compression and variational autoencoder methods for each stage, and specifies compression ratio parameters between 0.1 and 1.0 along with encryption depth parameters.

In an aspect of an embodiment, the data characterization processor computes entropy and variance statistics, extracts correlation coefficients for pattern detection, and generates confidence scores for data type classification to create comprehensive feature vectors.

In an aspect of an embodiment, the pipeline configuration controller validates configurations before deployment, implements buffering for smooth transitions between configurations, and maintains rollback capability for restoring previous configurations when performance degrades.

In an aspect of an embodiment, the performance monitor calculates a multi-objective reward function that balances compression ratio achievement with quality preservation while penalizing excessive computational cost and latency, providing stability bonuses when reconfiguration is unnecessary.

In an aspect of an embodiment, the system implements a second compression stage using a variational autoencoder trained with constrained loss functions that encourage dyadic latent space distributions while adding additional homomorphic encryption layers.

In an aspect of an embodiment, the variational autoencoder training uses a joint loss function combining reconstruction accuracy with distribution divergence penalties and regularization terms, with carefully tuned weighting parameters for optimal compression and distribution adherence.

In an aspect of an embodiment, an adaptive training subsystem continuously collects state-action-reward trajectories from production operations and performs periodic policy updates using Proximal Policy Optimization while maintaining safe exploration boundaries.

In an aspect of an embodiment, dynamic reconfiguration triggers when the performance monitor detects quality degradation exceeding 5% from baseline, latency increases beyond timeout values, or statistical analysis reveals significant data distribution shifts.

In an embodiment, a method implements adaptive compression and encryption using reinforcement learning following the same operational flow as the system embodiment, with corresponding aspects covering the same features and capabilities in method form.

### BRIEF DESCRIPTION OF THE DRAWING FIGURES

FIG. 1 is a block diagram illustrating the overall system architecture of reinforcement-learning enhanced adaptive compression pipeline.

FIG. 2 is a block diagram illustrating internal components and data flow of RL policy engine, including policy network, value network, and experience replay buffer.

FIG. 3 is a block diagram illustrating example configurations of the multi-stage compression pipeline for different data types and operational requirements.

FIG. 4 is a flowchart illustrating the initial configuration selection process for incoming data streams using feature extraction, policy inference, and validation.

FIG. 5 is a flowchart illustrating the dynamic reconfiguration process based on real-time performance monitoring and RL-driven adaptation during live data processing.

FIG. 6 is a flowchart illustrating the adaptive training and policy update process using PPO, validation, A/B testing, and gradual deployment of updated models.

FIG. 7 illustrates an exemplary computing environment on which an embodiment described herein may be implemented.

### DETAILED DESCRIPTION OF THE INVENTION

A system is disclosed for adaptive pipeline configuration utilizing reinforcement learning (RL) to dynamically adjust data processing workflows based on observed data attributes and real-time performance. The system architecture comprises several interoperable components: a data characterization processor, an RL policy engine, a pipeline configuration controller, a performance monitor, an adaptive training subsystem, and a configuration cache.

The data characterization processor analyzes incoming encrypted data streams, extracting features that inform subsequent decisions. Operations may include calculating entropy, variance, and other statistical descriptors; classifying the data modality (e.g., time series, imagery, audio, symbolic); estimating compression difficulty; identifying temporal or spatial patterns; and computing correlation metrics for multi-stream inputs. Outputs generated include a multi-dimensional feature vector, confidence scores for data classification, and metrics indicative of compression complexity and inter-stream relationships.

The RL policy engine serves as the principal decision-making component. It transforms extracted features into a structured state representation and applies learned policies to generate configuration actions. Elements of this engine include a state encoder, a policy network producing candidate configurations, a value network estimating expected performance, and an experience replay buffer for ongoing learning. Output decisions encompass compression stage count and sequencing, algorithm selection (e.g., traditional or neural-based), encryption layer structure, upsampling model choice, and fine-tuning parameters such as compression ratios and loss weightings.

The configuration controller translates decisions made by the RL policy engine into specific, executable pipeline topologies. In doing so, it manages the orchestration of resource allocation, initialization of each component with precise parameters, and validation against system and performance constraints. Where configurations fail to meet operational criteria, rollback functionality is engaged to restore the most recent stable state, ensuring service continuity. Parameters subject to configuration include stage activation flags, choice of compression method at each stage, transformation matrix attributes, and encryption depth, all tailored to the current data stream and performance objectives.

The system performs real-time monitoring across all operational phases, capturing a broad set of performance metrics such as compression ratios, stage-wise processing latencies, output quality measures (e.g., PSNR and SSIM), computational load including CPU and memory usage, power consumption, and end-to-end throughput. These observations are synthesized into a reward signal via a weighted function designed to balance competing objectives, including compression efficiency, data fidelity, processing delay, and resource consumption. This reward guides the RL policy engine in ongoing refinement, supporting adaptive responses to changing inputs and constraints.

To enable policy improvement during live deployment, the system includes an adaptive training subsystem. This subsystem continuously collects performance traces from active configurations and compiles them into training trajectories, which are then used in policy gradient-based learning updates. It supports A/B testing of novel configurations in shadow mode, where new policies are evaluated alongside the production policy under identical conditions. Safety mechanisms ensure that exploration is constrained within performance bounds to prevent instability, and performance regressions are avoided through automatic gating and rollback procedures.

A configuration cache stores successful prior configurations and makes them available for reuse based on input data similarity, reducing the latency and computational overhead associated with fresh policy evaluation. This cache employs a similarity-indexed lookup and tracks historical performance for each stored configuration, enabling performance-aware selection. Least Recently Used (LRU) eviction and adaptive replacement strategies maintain efficiency and relevance over time.

In typical operation, the system begins with an initial configuration phase in which early-stage data is sampled, characterized, and used to select an appropriate starting configuration. As the system processes live data, it enters an adaptive phase where performance is monitored continuously, and reconfiguration is triggered in response to data drift, degraded performance, or updated constraints. A learning phase runs concurrently, with training updates performed at regular intervals to assimilate the latest execution data into the RL policy.

Integration with legacy systems is facilitated through a set of clearly defined interfaces. These include control points before the first processing stage, between pipeline stages for dynamic bypass or substitution, and runtime parameter update mechanisms. Additionally, the system connects to existing quality monitors for closed-loop feedback. Because the RL operations are strictly limited to metadata analysis, the security of encrypted data is preserved, and homomorphic properties of processing chains remain intact.

Application scenarios include environments with stringent latency requirements such as financial trading platforms, high-fidelity demands such as medical imaging workflows, power-sensitive deployments like IoT sensor arrays, and privacy-focused systems handling genomic data. In each of these domains, the adaptive configuration process accounts for the unique performance constraints and optimizes the pipeline accordingly, using domain-informed priors where applicable.

The learning engine implements a version of Proximal Policy Optimization (PPO) that is tailored for environments involving encrypted data streams. It consumes a 48-dimensional feature vector incorporating descriptors of statistical characteristics, data type confidence scores, system resource status, and historical configuration effectiveness. The corresponding action space spans discrete configuration choices such as the number of processing stages, the nature of compression and encryption methods employed, and the upsampling strategy used to enhance output quality. A carefully tuned reward function drives the learning process, combining elements of compression performance, signal fidelity, computational efficiency, and configuration stability to ensure holistic pipeline optimization.

By integrating adaptive control, continuous feedback, and secure processing, the system enables real-time optimization of complex data pipelines across diverse operational environments.

One or more different aspects may be described in the present application. Further, for one or more of the aspects described herein, numerous alternative arrangements may be described; it should be appreciated that these are presented for illustrative purposes only and are not limiting of the aspects contained herein or the claims presented herein in any way. One or more of the arrangements may be widely applicable to numerous aspects, as may be readily apparent from the disclosure. In general, arrangements are described in sufficient detail to enable those skilled in the art to practice one or more of the aspects, and it should be appreciated that other arrangements may be utilized and that structural, logical, software, electrical and other changes may be made without departing from the scope of the particular aspects. Particular features of one or more of the aspects described herein may be described with reference to one or more particular aspects or figures that form a part of the present disclosure, and in which are shown, by way of illustration, specific arrangements of one or more of the aspects. It should be appreciated, however, that such features are not limited to usage in the one or more particular aspects or figures with reference to which they are described. The present disclosure is neither a literal description of all arrangements of one or more of the aspects nor a listing of features of one or more of the aspects that must be present in all arrangements.

Headings of sections provided in this patent application and the title of this patent application are for convenience only, and are not to be taken as limiting the disclosure in any way.

Devices that are in communication with each other need not be in continuous communication with each other, unless expressly specified otherwise. In addition, devices that are in communication with each other may communicate directly or indirectly through one or more communication means or intermediaries, logical or physical.

A description of an aspect with several components in communication with each other does not imply that all such components are required. To the contrary, a variety of optional components may be described to illustrate a wide variety of possible aspects and in order to more fully illustrate one or more aspects. Similarly, although process steps, method steps, algorithms or the like may be described in a sequential order, such processes, methods and algorithms may generally be configured to work in alternate orders, unless specifically stated to the contrary. In other words, any sequence or order of steps that may be described in this patent application does not, in and of itself, indicate a requirement that the steps be performed in that order. The steps of described processes may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to one or more of the aspects, and does not imply that the illustrated process is preferred. Also, steps are generally described once per aspect, but this does not mean they must occur once, or that they may only occur once each time a process, method, or algorithm is carried out or executed. Some steps may be omitted in some aspects or some occurrences, or some steps may be executed more than once in a given aspect or occurrence.

When a single device or article is described herein, it will be readily apparent that more than one device or article may be used in place of a single device or article. Similarly, where more than one device or article is described herein, it will be readily apparent that a single device or article may be used in place of the more than one device or article.

The functionality or the features of a device may be alternatively embodied by one or more other devices that are not explicitly described as having such functionality or features. Thus, other aspects need not include the device itself.

Techniques and mechanisms described or referenced herein will sometimes be described in singular form for clarity. However, it should be appreciated that particular aspects may include multiple iterations of a technique or multiple instantiations of a mechanism unless noted otherwise. Process descriptions or blocks in figures should be understood as representing modules, segments, or portions of code which include one or more executable instructions for implementing specific logical functions or steps in the process. Alternate implementations are included within the scope of various aspects in which, for example, functions may be executed out of order from that shown or discussed, including substantially concurrently or in reverse order, depending on the functionality involved, as would be understood by those having ordinary skill in the art.

### Definitions

The term “bit” refers to the smallest unit of information that can be stored or transmitted. It is in the form of a binary digit (either 0 or 1). In terms of hardware, the bit is represented as an electrical signal that is either off (representing 0) or on (representing 1).

The term “byte” refers to a series of bits exactly eight bits in length.

The term “codebook” refers to a database containing sourceblocks each with a pattern of bits and reference code unique within that library. The terms “library” and “encoding/decoding library” are synonymous with the term codebook.

The terms “compression” and “deflation” as used herein mean the representation of data in a more compact form than the original dataset. Compression and/or deflation may be either “lossless”, in which the data can be reconstructed in its original form without any loss of the original data, or “lossy” in which the data can be reconstructed in its original form, but with some loss of the original data.

The terms “compression factor” and “deflation factor” as used herein mean the net reduction in size of the compressed data relative to the original data (e.g., if the new data is 70% of the size of the original, then the deflation/compression factor is 30% or 0.3.)

The terms “compression ratio” and “deflation ratio”, and as used herein all mean the size of the original data relative to the size of the compressed data (e.g., if the new data is 70% of the size of the original, then the deflation/compression ratio is 70% or 0.7.)

The term “data” means information in any computer-readable form.

The term “data set” refers to a grouping of data for a particular purpose. One example of a data set might be a word processing file containing text and formatting information.

The term “effective compression” or “effective compression ratio” refers to the additional amount data that can be stored using the method herein described versus conventional data storage methods. Although the method herein described is not data compression, per se, expressing the additional capacity in terms of compression is a useful comparison.

The term “sourcepacket” as used herein means a packet of data received for encoding or decoding. A sourcepacket may be a portion of a data set.

The term “sourceblock” as used herein means a defined number of bits or bytes used as the block size for encoding or decoding. A sourcepacket may be divisible into a number of sourceblocks. As one non-limiting example, a 1 megabyte sourcepacket of data may be encoded using 512 byte sourceblocks. The number of bits in a sourceblock may be dynamically optimized by the system during operation. In one aspect, a sourceblock may be of the same length as the block size used by a particular file system, typically 512 bytes or 4,096 bytes.

The term “codeword” refers to the reference code form in which data is stored or transmitted in an aspect of the system. A codeword consists of a reference code to a sourceblock in the library plus an indication of that sourceblock's location in a particular data set.

The term “fully homomorphic encryption” refers to a cryptographic scheme that allows for arbitrary computations on encrypted data without the need for decryption.

The term “recursive encryption” refers to the process of applying multiple layers of homomorphic encryption to data, creating nested levels of security that can still be processed without decryption.

The term “Variational Autoencoder” or “VAE” refers to a type of neural network that is used to combine and transform encrypted data streams, particularly to achieve a nearly dyadic distribution in the latent space.

The term “nearly dyadic distribution” refers to a probability distribution that closely approximates a dyadic distribution, where probabilities are of the form ½\hat{ }k for some integer k.

The term “latent space variables” or “LSV” refers to the encoded representation of data within a Variational Autoencoder (VAE), which in this system are constrained to follow a nearly dyadic distribution.

The term “neural upsampler” refers to a neural network model designed to enhance the quality of decompressed data, recovering information lost during lossy compression.

The term “homomorphic operations” refers to computations that can be performed on encrypted data, producing results equivalent to performing the same operations on unencrypted data and then encrypting the result.

The term “secure multi-party computation” refers to a cryptographic technique that enables multiple parties to jointly compute a function over their inputs while keeping those inputs private.

The term “privacy-preserving federated learning” refers to a machine learning technique where a model is trained across multiple decentralized datasets without exchanging the raw data.

The term “granular access control” refers to a security mechanism that allows different levels of access to encrypted data based on authorization levels, typically implemented through recursive encryption.

The term “recursive application of homomorphic encryption” refers to the process of repeatedly applying layers of homomorphic encryption to data, creating multiple nested levels of encryption.

The term “reinforcement learning (RL)” refers to a machine learning paradigm in which an agent learns to make sequential decisions by interacting with an environment and receiving reward signals that reflect the quality of its actions over time.

The term “policy network” refers to a neural network component of a reinforcement learning system that receives a state vector as input and outputs a probability distribution over a predefined set of configuration actions.

The term “value network” refers to a neural network that estimates the expected cumulative reward associated with a given system state, supporting policy optimization through advantage estimation.

The term “state vector” refers to a structured, multi-dimensional data representation that captures the current input data characteristics, computational context, and historical performance metrics used by the RL policy engine to determine configuration decisions.

The term “action space” refers to the complete set of discrete configuration options that the RL policy engine may select from, including but not limited to stage count, compression method, encryption depth, and upsampler selection.

The term “Proximal Policy Optimization (PPO)” refers to a policy gradient reinforcement learning algorithm that updates neural network weights by maximizing a clipped objective function to stabilize training and prevent excessively large policy updates.

The term “experience replay buffer” refers to a memory structure that stores historical state-action-reward transitions generated during system operation, enabling batch-based learning and prioritized experience sampling.

The term “reward function” refers to a mathematical function used to quantify the effectiveness of a selected pipeline configuration by combining multiple performance metrics such as compression ratio, output quality, latency, and computational cost.

The term “configuration cache” refers to a storage and retrieval mechanism that retains previously successful pipeline configurations indexed by feature similarity, enabling fast configuration reuse without rerunning the policy network.

The term “dynamic reconfiguration” refers to the process by which system 100 adaptively modifies the active compression pipeline configuration in response to real-time changes in data characteristics or performance degradation.

The term “A/B testing framework” refers to a system deployment strategy that routes a portion of production data to a new configuration (the challenger) while the existing configuration (the champion) continues to serve the majority of traffic, allowing comparative evaluation of real-world performance.

The term “gradual rollout” refers to a staged model deployment process that progressively increases the proportion of production traffic allocated to a newly validated policy or configuration while monitoring key metrics and enabling rollback if needed.

### Foundational Conceptual Architecture

A system disclosed in U.S. application Ser. No. 19/012,202, filed on Jan. 15, 2025 and herein incorporated fully by reference, provides a multi-stage compression and encryption platform that processes data streams using dyadic distribution transformations and fully homomorphic encryption. The system maintains data in an encrypted state throughout all processing operations, enabling secure computation without decryption. This architecture addresses the fundamental challenge of performing complex data processing operations while preserving complete confidentiality, making it particularly valuable for sensitive applications in healthcare, finance, and secure communications.

The system, in an embodiment, implements a multi-stage compression process where each stage builds upon the previous one to achieve both enhanced compression efficiency and increased security. In the first compression stage, the system receives input data and analyzes its statistical properties to determine optimal processing parameters. The system then applies transformations designed to increase compressibility while maintaining data integrity, producing both a conditioned data stream and an error stream that captures transformation residuals. The conditioned data undergoes transformation into a dyadic distribution, which represents a probability distribution where probabilities take the form ½^{k} for integer k, enabling optimal efficiency in subsequent Huffman coding operations. A transformation matrix generator creates and manages the mathematical mappings required for reshaping the data distribution while preserving information content. After Huffman coding is performed on the transformed data, the system combines the encoded stream with a secondary transformation data stream to produce the first-stage compressed and encrypted output.

The second compression stage introduces a Variational Autoencoder (VAE) architecture that has been specifically trained to process encrypted data streams. This VAE receives the compressed and encrypted output from the first stage and encodes it into a latent space representation. The key innovation in this stage lies in the constrained training methodology that encourages the latent space variables to follow a nearly dyadic distribution. This constraint is achieved through a modified loss function that balances reconstruction accuracy with distributional requirements. The VAE's encoder portion maps the input data into this constrained latent space, while the decoder portion ensures that the original information can be accurately reconstructed. This second stage adds an additional layer of homomorphic encryption while further compressing the data through the dimensionality reduction inherent in the autoencoder architecture.

A decoder platform comprises, in an embodiment, several interconnected components that work together to process and enhance compressed data streams. The interleaver serves as the initial reception point for compressed data streams, handling data preparation and metadata extraction. Even in lossy compression modes where no secondary stream requires de-interleaving, the interleaver performs crucial functions including header processing, metadata parsing, and coordination with the security module. The security module ensures data integrity through cryptographic verification and manages the homomorphic encryption operations throughout the decoding process. The Huffman decoder performs the decompression operation using the appropriate codebook, which may be transmitted alongside the compressed data or standardized between encoder and decoder. The neural upsampler represents a sophisticated enhancement component that processes the decompressed data to recover information lost during lossy compression. This component leverages trained neural networks to recognize patterns in the degraded data and synthesize missing details based on learned correlations. A data quality estimator continuously assesses the output quality and provides feedback to optimize the upsampling process, enabling adaptive behavior based on data characteristics and quality requirements.

The dyadic distribution transformation represents a fundamental mathematical innovation that enables optimal compression efficiency while maintaining compatibility with homomorphic encryption operations. The transformation process begins with statistical analysis of the input data to determine its probability distribution characteristics. The system then generates transformation matrices that map the original distribution to a dyadic form, where each probability value can be expressed as ½^{k} for some integer k. This transformation is carefully designed to preserve information content while achieving a distribution that allows Huffman coding to reach theoretical compression limits. The mathematical mapping employs techniques from information theory and linear algebra to ensure that the transformation is reversible and that no information is lost during the distribution reshaping process.

A VAE training process employs a sophisticated joint loss function that balances multiple objectives to achieve the desired system behavior. The loss function combines three primary components: reconstruction loss, distribution divergence, and regularization terms. The reconstruction loss, typically measured using mean squared error or similar metrics, quantifies how accurately the VAE can recover the original input from its latent representation. The distribution divergence term measures how closely the latent space variables follow the target dyadic distribution, using techniques such as Kullback-Leibler divergence adapted for discrete distributions. The regularization terms prevent overfitting and encourage the network to learn generalizable patterns rather than memorizing specific training examples. The overall loss function can be expressed as Loss=α·L_reconstruction+β·L_divergence+γ·L_regularization, where α, β, and γ are weighting parameters that control the relative importance of each objective. During training, these parameters are carefully tuned to ensure that the VAE achieves high reconstruction accuracy while maintaining the distributional constraints necessary for optimal compression and encryption.

The homomorphic encryption operations within the system are built upon fundamental mathematical properties that allow computations on encrypted data. The system supports addition and multiplication operations on encrypted values, where Enc(a)+Enc(b)=Enc(a+b) and Enc(a)×Enc(b)=Enc(a× b), forming the basis for more complex computations. These primitive operations can be combined to implement sophisticated algorithms including statistical analyses, machine learning inference, and signal processing operations, all while maintaining the encrypted state of the data. The mathematical framework ensures that the results of operations performed on encrypted data are identical to those that would be obtained by decrypting the data, performing the operations, and then re-encrypting the results. This property, known as homomorphism, is preserved across all compression stages and processing operations within the system.

The security architecture implements a layered encryption approach where each compression stage adds a homomorphic encryption layer, creating a nested security structure that provides both depth of protection and granular access control. The first stage begins with initial fully homomorphic encryption applied at the data source, ensuring that sensitive information is protected from the moment of collection. This initial encryption uses established FHE schemes that support the mathematical operations required for subsequent processing. As data progresses through the compression pipeline, the second stage adds an additional encryption layer through the VAE processing, where the transformation into latent space effectively creates another level of cryptographic protection. Subsequent stages can add further encryption layers as needed, with each layer maintaining its own encryption parameters and keys, enabling fine-grained access control where different authorized parties can be granted decryption capabilities for specific layers based on their authorization level.

The system maintains end-to-end encryption throughout all processing operations, ensuring that no plaintext data is ever exposed during compression, transmission, storage, or analysis. This is achieved through careful implementation of homomorphic operations that preserve the encrypted state while allowing meaningful computations. The security module coordinates these operations, managing encryption keys, verifying data integrity through homomorphic hash functions, and ensuring that all transformations maintain the security properties of the underlying encryption scheme. The integrity verification process uses cryptographic techniques such as SHA-256 or SHA-3 adapted for homomorphic computation, creating and verifying hash values at various processing stages without requiring decryption. Digital signatures based on asymmetric encryption provide authentication and non-repudiation, ensuring that data sources can be verified and that tampering can be detected.

A neural upsampler training process implements a sophisticated machine learning approach designed to recover information lost during lossy compression while operating on encrypted data streams. The training methodology begins with the creation of comprehensive paired datasets that represent the types of data the system will encounter in production use. For each data sample, the training system maintains both an original, uncompressed version serving as ground truth and a lossy-compressed version that has been processed through the compression pipeline. This paired approach allows the neural network to learn the relationship between degraded and high-quality data, developing an understanding of how compression artifacts manifest and how missing information can be reconstructed.

A network architecture employed for upsampling is tailored to the specific characteristics of the data being processed. For spatial data such as images, the network utilizes convolutional layers that can capture local patterns and spatial relationships. For sequential data like time series or audio, recurrent layers or attention mechanisms capture temporal dependencies. The network learns to extract relevant features from the degraded input data, recognizing patterns that indicate what the original, uncompressed information looked like. Through extensive training on diverse datasets, the network develops the ability to synthesize missing details, whether interpolating missing values in time series data, reconstructing fine details in images, or recovering frequency components in audio signals. The training process employs task-specific loss functions appropriate to the data type, such as mean squared error for numerical data, structural similarity index for images, or perceptual loss functions for audio and video content.

A training system implements continuous adaptation and improvement through several mechanisms. Data augmentation techniques increase the diversity of training examples by applying transformations such as scaling, shifting, and noise addition for time series data, or rotation, flipping, and color adjustments for image data. A separate validation dataset monitors the model's performance on unseen data, preventing overfitting and guiding hyperparameter optimization. The system can maintain multiple specialized models, each optimized for different data types or compression levels, with an intelligent selection mechanism choosing the most appropriate model based on the characteristics of incoming data. Online learning capabilities allow the models to make small adjustments based on recent data, helping the system adapt to gradual changes in data characteristics over time.

The encoding process follows a systematic flow designed to maximize both compression efficiency and security while maintaining data integrity throughout. Upon receiving an input data stream, the system first applies initial fully homomorphic encryption, transforming the plaintext data into a form that supports subsequent homomorphic operations. The encrypted data then enters the first compression stage, where statistical analysis determines optimal processing parameters. Transformations are applied to increase compressibility, producing conditioned data and error streams that capture the complete information content. The conditioned data undergoes transformation into a dyadic distribution, followed by Huffman coding that achieves near-optimal compression for the transformed distribution. The encoded data is combined with transformation parameters to create the first-stage output, which then serves as input to the second compression stage.

In the second stage, a VAE processes the already compressed and encrypted data, encoding it into a latent space representation that follows a nearly dyadic distribution. This encoding adds another layer of both compression and encryption, as the latent space transformation effectively scrambles the data in a way that can only be reversed with the trained decoder network. The system can apply additional compression stages as needed, with each stage building upon the previous ones to achieve the desired balance of compression ratio, security level, and computational efficiency. Throughout this process, metadata is generated and maintained, documenting the compression parameters, encryption schemes, and other information necessary for successful decoding.

The decoding process reverses the encoding operations while maintaining encryption until the final authorized decryption point. The decoder receives the multi-stage compressed and encrypted stream along with its associated metadata. Processing begins with the outermost compression layer, applying the corresponding decompression operations in reverse order. For stages that used the VAE, the decoder portion of the network reconstructs the data from its latent representation. For stages using traditional compression, Huffman decoding and inverse transformations restore the data structure. At each stage, the neural upsampler can be applied to enhance data quality, recovering information lost during lossy compression. The data quality estimator evaluates the reconstruction quality and can trigger reprocessing with different parameters or models if the quality falls below acceptable thresholds. This adaptive approach ensures optimal quality while maintaining security, as all enhancement operations occur on the encrypted data.

### Adaptive Pipeline Configuration Using Reinforcement Learning System Architecture

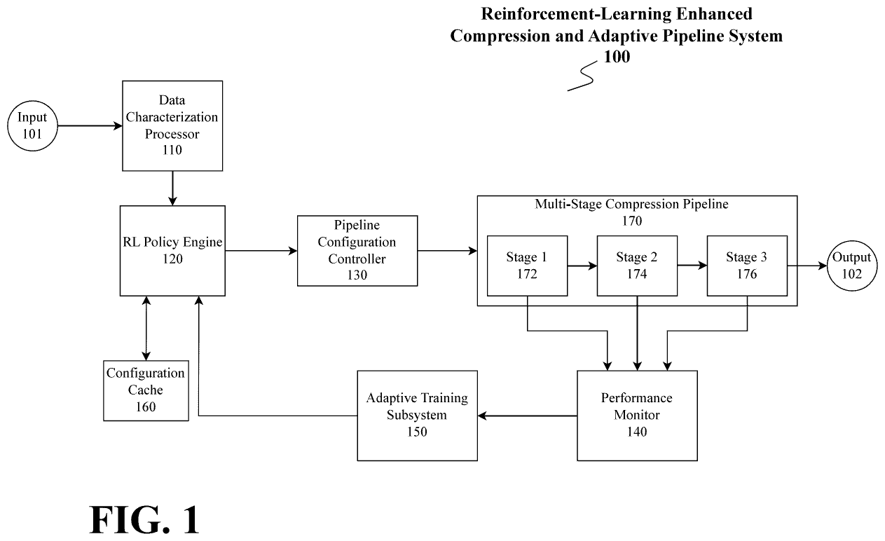

FIG. 1 is a block diagram illustrating an exemplary architecture of a reinforcement-learning enhanced compression and adaptive pipeline system 100, in an embodiment. System 100 receives an encrypted data stream 101 as input, which is first processed by a data characterization processor 110. Data characterization processor 110 analyzes the encrypted input to extract statistical features, data type classifications, and compression complexity estimates, performing all operations without decrypting the input data, thereby maintaining end-to-end security through fully homomorphic encryption.

Data characterization processor 110 transmits extracted features to a reinforcement learning (RL) policy engine 120, which serves as the core decision-making component of system 100. RL policy engine 120 comprises a policy network, value network, and experience replay buffer. Based on the received feature vector, RL policy engine 120 determines an optimal configuration for a multi-stage compression pipeline. Configuration decisions generated by RL policy engine 120 are forwarded to both a configuration cache 160 and a pipeline configuration controller 130. The RL policy engine 120 interfaces with the compression stages described in the parent application by analyzing the output characteristics of each stage. For example, when the first compression stage produces a dyadic distribution with entropy above a threshold, the RL engine may activate the VAE second stage to achieve further compression while maintaining the dyadic properties essential for optimal Huffman coding efficiency. During decoding operations performed by a decoder platform, the RL policy engine's configuration decisions are preserved in metadata, enabling the decoder to apply the inverse operations in the correct sequence and with appropriate parameters for neural upsampling.

Configuration cache 160 maintains a repository of successful prior configurations indexed by data characteristics, enabling rapid reuse of previously effective configurations when similar data profiles are detected. This caching functionality reduces inference latency and computational load by bypassing redundant evaluations for familiar inputs.

Pipeline configuration controller 130 receives configuration directives from RL policy engine 120 and translates them into executable parameters for the compression pipeline. Controller 130 performs pipeline topology construction, resource allocation, parameter initialization, and configuration validation. In the event of deployment failure or performance regression, controller 130 supports rollback to a previously validated configuration.

A multi-stage compression pipeline 170 includes up to three sequential processing stages: a first stage implementing traditional compression algorithms 172, a second stage capable of applying either variational autoencoder (VAE) or traditional compression methods 174, and a third stage that provides additional compression conditioned on data complexity or system objectives 176. Pipeline configuration controller 130 dynamically activates and configures each stage based on current system conditions and policy outputs. All stages operate on encrypted data, preserving homomorphic encryption across the entire pipeline.

As the encrypted data is processed through the pipeline, performance metrics are collected in real time and transmitted to a performance monitor 140. Monitored parameters include compression ratios, processing latency, output quality metrics such as PSNR and SSIM, and resource usage indicators including CPU, memory, and power consumption. These metrics serve dual functions.

First, performance metrics are transmitted to an adaptive training subsystem 150 as quantified reward signals, which reflect the effectiveness of the current configuration with respect to multi-objective optimization goals. Adaptive training subsystem 150 uses these signals, along with logged state-action histories, to perform reinforcement learning updates using Proximal Policy Optimization (PPO). This subsystem supports A/B testing of alternative configurations and gradual rollout of updated policies to RL policy engine 120.

Second, performance monitor 140 is configured to trigger immediate reconfiguration actions via a direct feedback path to pipeline configuration controller 130. When real-time metrics indicate degraded quality, unacceptable latency, or a significant shift in data characteristics, controller 130 is prompted to implement an updated configuration without waiting for the next RL training cycle. This dual-loop architecture enables both immediate responsiveness and long-term policy refinement.

The final output of the system is a compressed and encrypted data stream 102 that has been adaptively processed based on data characteristics and system constraints, with all computations performed securely under homomorphic encryption. System 100 thereby enables intelligent, real-time adaptation of compression pipelines, achieving optimal performance across diverse data types while preserving end-to-end data confidentiality.

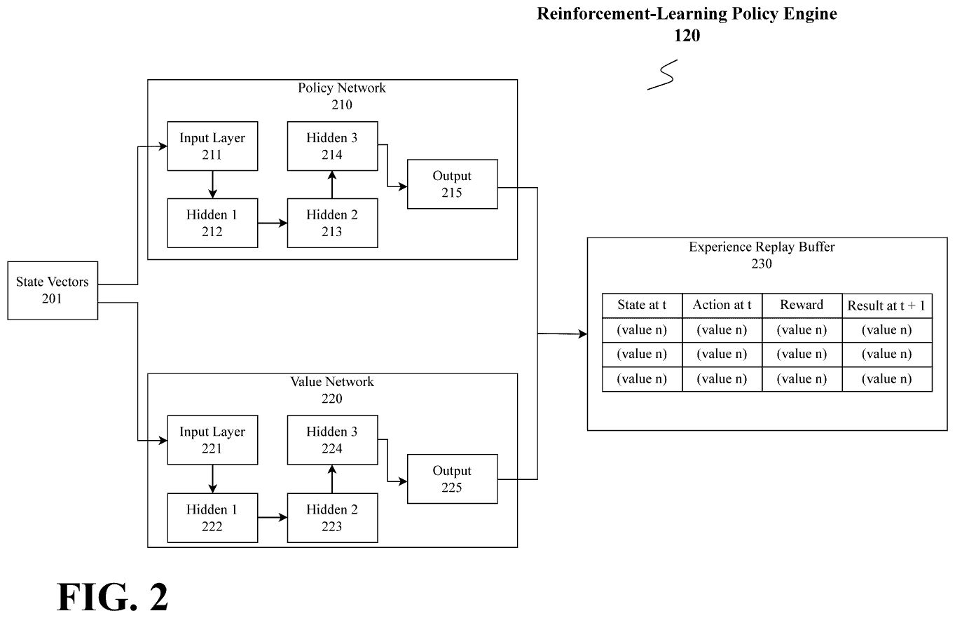

FIG. 2 is a block diagram illustrating exemplary architecture of RL policy engine 120 showing internal components and data flow, in an embodiment. State vectors 201 comprise 48 dimensions of input data organized into four categories: 20 dimensions of statistical features, 8 dimensions of data type indicators, 10 dimensions of computational context, and 10 dimensions of historical performance metrics. State vectors 201 serve as the primary input to both policy network 210 and value network 220 within RL policy engine 120.

Policy network 210 processes state vectors 201 through a multi-layer neural network architecture beginning with input layer 211 containing 48 neurons corresponding to the dimensionality of state vector 201. Input layer 211 feeds forward to hidden layer 1 212, which comprises 256 neurons with ReLU activation functions. Hidden layer 1 212 connects to hidden layer 2 213 containing 128 neurons, also utilizing ReLU activation. Hidden layer 2 213 feeds into hidden layer 3 214 with 64 neurons and ReLU activation. The final layer of policy network 210 is output layer 215 containing 15 neurons with softmax activation, producing a probability distribution over the discrete action space. The action space represented by output layer 215 encompasses 5 options for number of compression stages, 3 options for compression aggressiveness, 3 options for encryption mode, and 4 options for neural upsampler selection. Value network 220 shares initial layers with policy network 210, specifically utilizing the same input layer 221 and first two hidden layers 222 and 223, which correspond to layers 211, 212, and 213 of policy network 210. This weight sharing between networks improves training efficiency and ensures consistent feature extraction. Value network 220 diverges at hidden layer 3 224, which contains 32 neurons with ReLU activation, distinct from the 64-neuron configuration in policy network 210. Output layer 225 of value network 220 consists of a single neuron with linear activation that outputs the estimated state value V(s) for the input state.

Experience replay buffer 230 stores historical state-action-reward-next-state tuples generated during system operation. Buffer structure within experience replay buffer 230 organizes experiences with fields for state at time t, action taken at time t, reward received, and resulting state at time t+1. Experience replay buffer 230 maintains a capacity of 100,000 experiences with prioritized sampling based on temporal difference error, enabling more efficient learning from significant experiences. The buffer implements a 7-day rolling window retention policy and samples batches of 64 experiences for training updates performed every 1000 steps of system operation.

PPO training parameters govern the learning process within RL policy engine 120, including clip ratio of 0.2 to limit policy updates, learning rate of 3e−4 for gradient descent, discount factor gamma of 0.99 for future reward weighting, GAE lambda of 0.95 for advantage estimation, 10 training epochs per update cycle, minibatch size of 64 for gradient computation, and maximum gradient norm of 0.5 for stability.

During operation, state vector 201 flows into both policy network 210 and value network 220 simultaneously. Policy network 210 generates action probabilities that determine configuration decisions, while value network 220 estimates the expected performance of the current state. These outputs, along with subsequently observed rewards, populate experience replay buffer 230. The accumulated experiences undergo periodic processing through PPO update algorithms, which compute policy gradients and value function updates that flow back to modify the weights of both networks, creating a continuous learning cycle that improves configuration decisions based on observed system performance.

The configuration decision output from policy network 210 represents the selected discrete actions across all decision dimensions, which pipeline configuration controller 130 translates into specific pipeline parameters for implementation in the multi-stage compression system.

RL policy engine 120 interfaces directly with the compression architecture disclosed in the parent application by analyzing output characteristics from each compression stage to make informed configuration decisions. When the first compression stage produces a dyadic distribution with entropy measurements exceeding predetermined thresholds, RL policy engine 120 evaluates whether activating the VAE second stage would achieve meaningful additional compression while maintaining the dyadic properties essential for optimal Huffman coding efficiency. In this embodiment, policy network 210 has been trained to recognize data patterns that benefit from VAE processing, such as high-dimensional data with complex correlations that can be effectively mapped to a constrained latent space following nearly dyadic distributions.

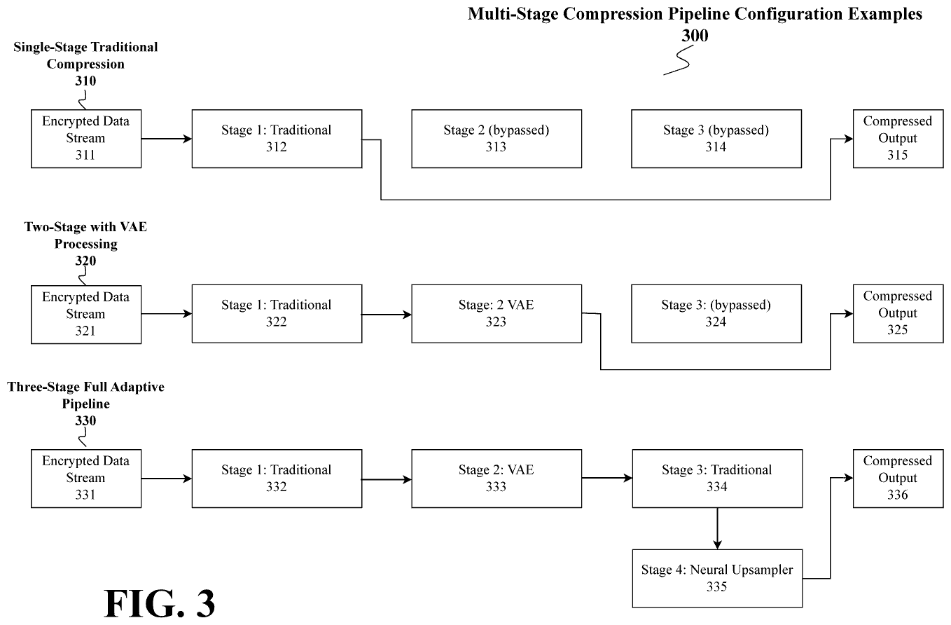

FIG. 3 is a block diagram illustrating exemplary multi-stage compression pipeline configuration examples demonstrating adaptive configuration selection by RL policy engine 120 for different data types and requirements, in an embodiment. Configuration example 310 shows single-stage traditional compression optimized for IoT sensor data with low latency requirements. In configuration 310, encrypted data stream enters stage 1 311, which implements traditional compression using delta encoding and Huffman coding to achieve 15:1 compression ratio. Stage 2 312 and stage 3 313 remain bypassed, with data flowing directly from stage 1 311 to compressed output 315, minimizing processing latency for time-critical sensor applications.

Configuration example 320 demonstrates 2-stage processing with VAE for medical imaging applications where quality preservation is critical. Encrypted MRI scan data enters stage 1 321 implementing traditional compression through wavelet transform and entropy coding, achieving 2.8:1 compression ratio while preserving image structure. Stage 1 321 output flows to stage 2 322, which employs a variational autoencoder with 256-dimensional latent space and dyadic distribution constraints, adding 2.1:1 compression for combined ratio of 5.88:1. Stage 3 323 remains bypassed in this configuration. Quality metrics indicate SSIM of 0.96 and PSNR of 42 dB, confirming high fidelity preservation suitable for medical diagnosis requirements.

Configuration example 330 illustrates full 3-stage adaptive pipeline for financial trading data requiring both high compression and maximum security. Trading data 331 enters stage 1 332 performing time series analysis and predictive coding for 3.5:1 compression by exploiting temporal patterns in financial data. Stage 2 333 applies VAE processing with 128-dimensional latent space optimized for pattern learning, contributing 1.7:1 additional compression. Stage 3 334 implements fine-grain coding with extra encryption layer, providing 1.4:1 compression while enhancing security through additional homomorphic encryption. Neural upsampler 335 operates in quality mode to enhance reconstruction accuracy, with the complete pipeline achieving 8.33:1 total compression ratio. Neural upsampler 335 operates on the decompressed output data to enhance reconstruction quality, particularly in scenarios where minor fidelity loss may impact downstream analysis. Encryption indicators show three active layers: base encryption maintained throughout, VAE-added encryption from stage 2 333, and additional security layer from stage 3 334. System latency measures 4.2 ms, meeting real-time processing requirements for financial applications.

Configuration selection criteria guide RL policy engine 120 decisions based on data characteristics and operational requirements. Single-stage configurations suit low-complexity data with stringent latency constraints, such as IoT telemetry. Two-stage configurations with VAE processing handle complex patterns where quality preservation outweighs latency concerns, typical in medical imaging. Three-stage full pipeline configurations maximize both compression efficiency and security for high-value data tolerating moderate latency, common in financial and genomic applications. Neural upsampler activation occurs when reconstruction quality enhancement justifies additional computational overhead, as determined by performance monitor 140 feedback to RL policy engine 120.

During VAE operation in the second compression stage, RL policy engine 120 dynamically optimizes the loss function parameters described in the parent application as Loss=α·L_reconstruction+β·L_divergence+γ·L_regularization. Based on real-time analysis of data characteristics, the RL system adjusts weighting parameters α, β, and γ to balance reconstruction accuracy against distributional constraints. For medical imaging data, the system may increase α to prioritize reconstruction fidelity, while for financial time series data, it may increase β to ensure tighter adherence to dyadic distributions that maximize subsequent compression efficiency. These parameter adjustments occur within bounds established during training to ensure stable VAE operation while adapting to data-specific requirements.

The integration extends to decoder platform operations, where RL policy engine 120 configuration decisions are preserved as metadata within the compressed stream. When a decoder platform receives compressed data, it extracts these RL-generated parameters to properly sequence decompression operations and configure neural upsampler settings. For instance, if RL policy engine 120 determined that aggressive compression was applied due to bandwidth constraints, this information guides a decoder platform to apply enhanced neural upsampling with models specifically trained for high compression ratio recovery. The bidirectional flow of information between encoder and decoder platforms ensures that RL-optimized configurations achieve their intended benefits throughout the complete compression-decompression cycle.

For multi-stage compression beyond the three stages shown in configuration examples, RL policy engine 120 evaluates the diminishing returns of additional compression stages against computational costs and latency constraints. The parent application's architecture supports subsequent stages that each add homomorphic encryption layers, and RL policy engine 120 determines the optimal number of stages by monitoring the rate of compression improvement. When compression gains fall below 5% while latency increases exceed 20%, the system typically terminates additional stage processing. This adaptive stage selection ensures efficient resource utilization while maximizing compression effectiveness for each specific data type and operational context.

These configuration examples demonstrate the adaptability of RL policy engine 120 in selecting optimal pipeline structures and parameters based on real-time performance objectives. It should be understood that these configurations are illustrative and not limiting, and that other pipeline arrangements may be selected by the system based on differing input characteristics or operational requirements.

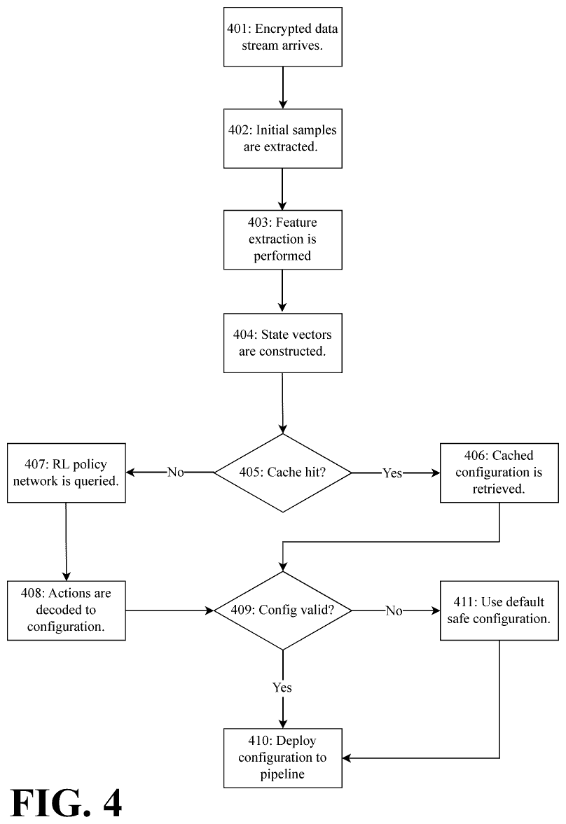

FIG. 4 is a flowchart illustrating initial configuration selection process performed by RL policy engine 120 when establishing pipeline parameters for incoming data streams, in an embodiment. The process begins when encrypted data stream arrives at system 100, triggering the configuration selection sequence 401. Data characterization processor 110 extracts initial samples from the incoming stream, collecting 1000 samples within a 100 ms window to ensure statistically significant representation of data characteristics 402.

Feature extraction operations analyze the sampled data across multiple dimensions, computing, for example, 20 statistical features including entropy and variance measures, generating 8 data type classification scores indicating confidence levels for different data modalities, extracting 10 computational context parameters reflecting current system resource availability, and retrieving 10 historical performance metrics from previous similar data processing operations 403. These extracted features combine to construct a comprehensive 48-dimensional state vector that encapsulates all relevant information needed for configuration decision-making 404.

Configuration cache 160 is checked to determine whether a suitable configuration already exists for data with similar characteristics 405. Cache lookup operations compare the current state vector against stored configurations using similarity metrics, achieving sub-millisecond response times when matching entries are found. When cache hit occurs, the system retrieves the previously successful configuration directly, bypassing neural network computation to minimize latency 406.

If cache miss occurs, RL policy engine 120 queries policy network 210 with the constructed state vector to generate configuration decisions 407. Policy network 210 processes the 48-dimensional input through its multi-layer architecture and outputs 15 discrete actions representing configuration choices. Action decoding translates these 15 discrete outputs into a complete pipeline configuration specification, mapping action indices to specific compression stages, algorithm selections, encryption parameters, and upsampler settings 408.

Configuration paths from both cache retrieval and policy network generation converge at pipeline configuration controller 130 validates the proposed configuration against system constraints, resource availability, and safety parameters 409. Validation checks ensure requested compression stages are compatible, computational resources are sufficient for the specified algorithms, encryption depth does not exceed homomorphic operation limits, and quality thresholds can be maintained with selected parameters.

Valid configurations proceed to deployment phase where pipeline configuration controller 130 initializes the multi-stage compression pipeline with specified parameters 410. Invalid configurations trigger fallback to a conservative default configuration that guarantees stable operation, typically employing single-stage traditional compression with standard encryption depth 411. The default configuration path rejoins the main flow to ensure processing can begin regardless of validation outcome.

Processing commences once configuration deployment completes, with the selected pipeline parameters governing all subsequent data compression and encryption operations. Total configuration time typically ranges from 15-20 ms for policy network evaluation paths, reducing to less than 1 ms for cache hits. The process achieves 85-95% cache hit rates for stable workloads, significantly reducing average configuration latency and computational overhead through effective configuration reuse.

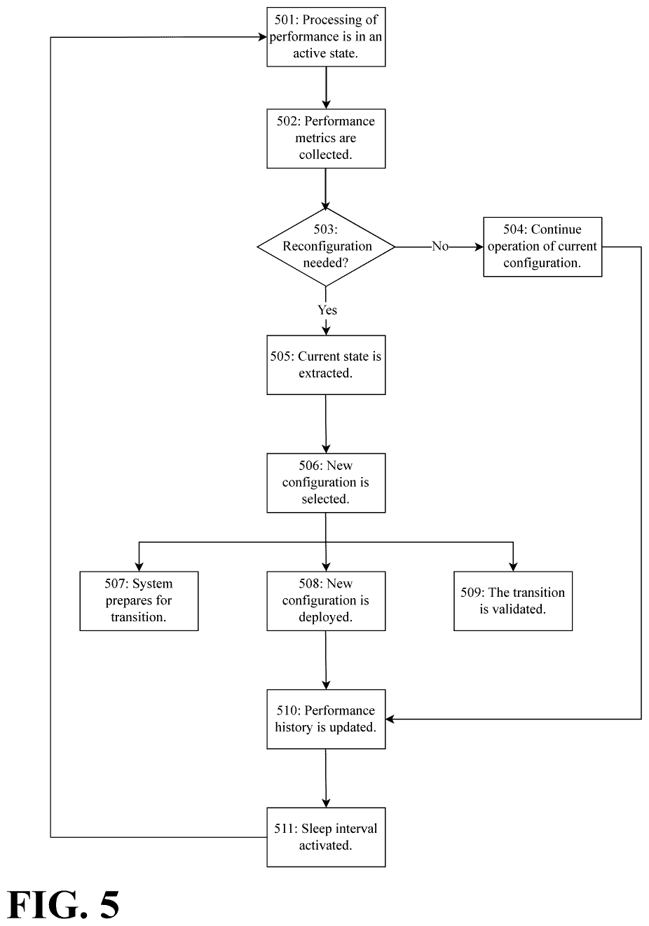

FIG. 5 is a flowchart illustrating dynamic reconfiguration process executed by system 100 to adapt pipeline configuration during active data processing based on performance feedback, in an embodiment. The process operates as a continuous loop while data processing remains active, ensuring constant monitoring and optimization of compression pipeline performance 501. Performance monitor 140 collects comprehensive metrics every 100 ms, including current compression ratios, processing latency measurements, output quality scores, and CPU usage statistics 502.

System 100 evaluates collected metrics against predefined reconfiguration triggers to determine if pipeline adjustment is necessary 503. Three primary trigger conditions are monitored in this embodiment: quality degradation exceeding 5% from established baseline values, processing latency surpassing timeout thresholds defined for the current data type, and statistical detection of data distribution shifts using Kullback-Leibler divergence measurements. When no triggers activate, the system continues operating with current configuration, maintaining stable processing without disruption 504.

Upon trigger detection, data characterization processor 110 extracts current state information from the active data stream, generating a new 48-dimensional feature vector that reflects the changed conditions 505. This updated state vector captures the altered data characteristics or system conditions that necessitated reconfiguration. RL policy engine 120 processes the new state vector through policy network 210 to select an optimized configuration suited to current conditions 506.

Pipeline configuration controller 130 initiates transition preparation by allocating 10 MB buffers to queue incoming data during the reconfiguration process 507. This buffering mechanism ensures zero data loss during configuration changes by temporarily storing arriving data while the pipeline restructures. Simultaneously, pipeline configuration controller 130 deploys the new configuration using atomic switching operations that instantaneously replace the old pipeline structure with the new one 508.

Validation procedures verify transition success by checking data flow continuity and confirming performance metrics meet expected values within a 500 ms timeout window 509. The validation process ensures the new configuration operates correctly and achieves intended improvements without introducing instability or degradation. Both the reconfigured pipeline path and the unchanged configuration path converge at performance history update operations.

Performance monitor 140 updates historical performance records with current metrics, maintaining a comprehensive log of system behavior across different configurations and conditions 510. This historical data feeds back into RL policy engine 120 for continuous learning and improvement of configuration decisions. The monitoring loop includes a 100 ms sleep interval between iterations to balance responsive monitoring with computational efficiency 511.

The process returns to the monitoring phase, creating a continuous cycle of monitoring, evaluation, and adaptation throughout the active processing session. Reconfiguration statistics indicate typical detection times under 100 ms, transition completion within 500 ms, guaranteed zero data loss through buffering, and reconfiguration frequencies ranging from 1-10 times per hour depending on data stability. An example scenario illustrates how a workload shift from MRI imaging with high spatial correlation to ultrasound with temporal patterns triggers VAE model changes to optimize compression for the new data characteristics.

This example scenario is illustrative and not limiting; other data modality shifts or system constraints may trigger alternative reconfiguration sequences.

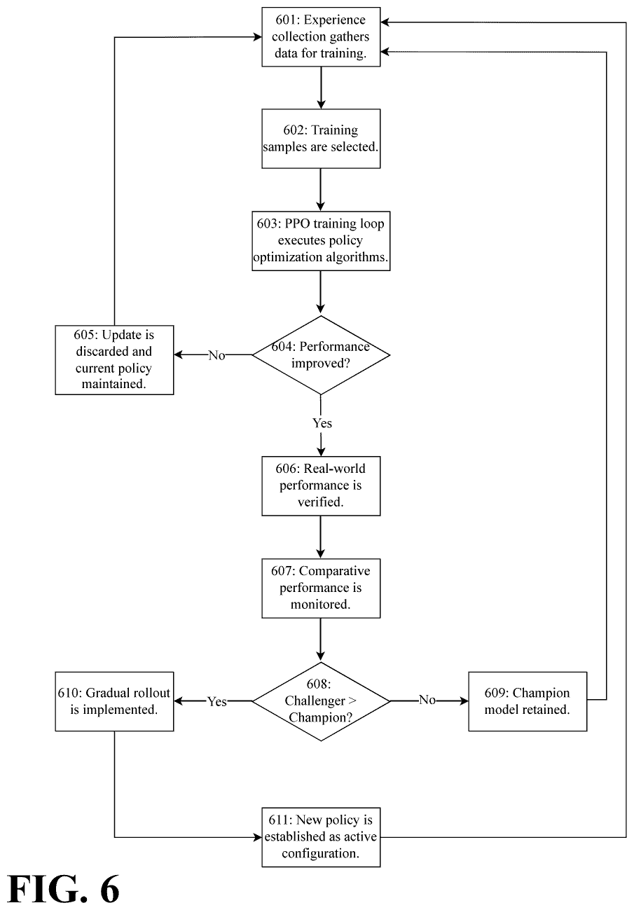

FIG. 6 is a flowchart illustrating adaptive training and policy update flow implemented by adaptive training subsystem 150 to continuously improve RL policy engine 120 based on production performance data, in an embodiment. All training and evaluation processes occur asynchronously, ensuring that production performance remains unaffected during learning cycles.

Experience collection operates continuously during production, gathering state-action-reward tuples from every configuration decision and its resulting performance outcomes, maintaining a rolling buffer of 100,000 experiences for training purposes 601.

Batch formation processes select training samples from the experience buffer using prioritized sampling based on temporal difference error, ensuring the most informative experiences receive greater weight in training updates 602. The system forms batches of 64 experiences and initiates training updates every 10,000 processing steps to balance learning frequency with computational efficiency.

PPO training loop executes the core policy optimization algorithm across 10 epochs per update cycle 603. Within each epoch, the system calculates advantage estimates using Generalized Advantage Estimation (GAE) to determine how much better or worse actions performed relative to expectations. Policy network 210 updates occur through clipped objective functions that limit the magnitude of policy changes to ensure training stability. Value network 220 updates simultaneously to improve state value predictions based on observed rewards.

Model validation evaluates the updated policy against holdout data to ensure genuine performance improvements before deployment consideration 604. Validation criteria require testing on 1000 samples from each major data type category, demonstrating performance improvement exceeding 2% over the current policy, and achieving statistical significance with p-value less than 0.01. Failed validation results in discarding the update and maintaining the current policy without disruption to production operations 605.

Successfully validated policies proceed to A/B testing framework for real-world performance verification 606. The testing configuration allocates 5% of incoming traffic to the challenger model while the champion model continues processing 95% of traffic, enabling safe evaluation under actual operating conditions.

A/B testing framework monitors comparative performance between champion and challenger models over 24 hours or 1 million processed samples, whichever occurs first 607. The framework tracks comprehensive metrics including compression ratios, processing latency, quality scores, and resource utilization to determine whether the challenger model delivers meaningful improvements.

A/B test results evaluation determines whether the challenger model outperforms the champion with statistical confidence 608. Successful challengers that demonstrate superior performance proceed to gradual rollout phases, while unsuccessful challengers result in retaining the champion model and continuing standard monitoring operations 609.

Gradual rollout implements progressive traffic allocation to minimize risk during model deployment 610. Traffic allocation increases from initial 5% to 10% after 2 hours of stable performance, then to 25% after 6 hours, 50% after 12 hours, and finally 100% after 24 hours of consistent improvement. Each rollout stage includes performance monitoring and automatic rollback capabilities if degradation occurs.

Production deployment completes the update cycle by establishing the new policy as the active configuration selector for all incoming data 611. The successfully deployed policy becomes the new champion model against which future improvements will be measured.

The complete adaptive training flow creates a continuous learning loop where experiences from the deployed model feed back into experience collection, enabling ongoing refinement and optimization 612. Training statistics indicate daily update attempts with approximately 30% passing validation, 40% of validated models winning A/B tests, and net system performance improvements of 2-5% monthly through this continuous optimization process. The process ensures that each deployed policy contributes new experience data, perpetuating the cycle of performance-driven learning.

### Exemplary Computing Environment

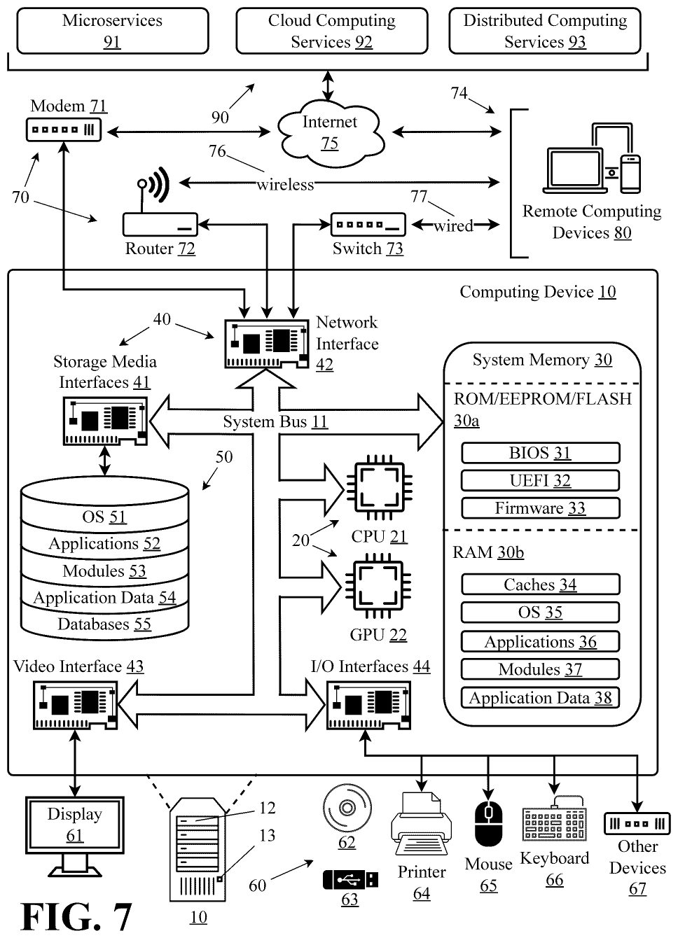

FIG. 7 illustrates an exemplary computing environment on which an embodiment described herein may be implemented, in full or in part. This exemplary computing environment describes computer-related components and processes supporting enabling disclosure of computer-implemented embodiments. Inclusion in this exemplary computing environment of well-known processes and computer components, if any, is not a suggestion or admission that any embodiment is no more than an aggregation of such processes or components. Rather, implementation of an embodiment using processes and components described in this exemplary computing environment will involve programming or configuration of such processes and components resulting in a machine specially programmed or configured for such implementation. The exemplary computing environment described herein is only one example of such an environment and other configurations of the components and processes are possible, including other relationships between and among components, and/or absence of some processes or components described. Further, the exemplary computing environment described herein is not intended to suggest any limitation as to the scope of use or functionality of any embodiment implemented, in whole or in part, on components or processes described herein.

The exemplary computing environment described herein comprises a computing device 10 (further comprising a system bus 11, one or more processors 20, a system memory 30, one or more interfaces 40, one or more non-volatile data storage devices 50), external peripherals and accessories 60, external communication devices 70, remote computing devices 80, and cloud-based services 90.

System bus 11 couples the various system components, coordinating operation of and data transmission between those various system components. System bus 11 represents one or more of any type or combination of types of wired or wireless bus structures including, but not limited to, memory busses or memory controllers, point-to-point connections, switching fabrics, peripheral busses, accelerated graphics ports, and local busses using any of a variety of bus architectures. By way of example, such architectures include, but are not limited to, Industry Standard Architecture (ISA) busses, Micro Channel Architecture (MCA) busses, Enhanced ISA (EISA) busses, Video Electronics Standards Association (VESA) local busses, a Peripheral Component Interconnects (PCI) busses also known as a Mezzanine busses, or any selection of, or combination of, such busses. Depending on the specific physical implementation, one or more of the processors 20, system memory 30 and other components of the computing device 10 can be physically co-located or integrated into a single physical component, such as on a single chip. In such a case, some or all of system bus 11 can be electrical pathways within a single chip structure.

Computing device may further comprise externally-accessible data input and storage devices 12 such as compact disc read-only memory (CD-ROM) drives, digital versatile discs (DVD), or other optical disc storage for reading and/or writing optical discs 62; magnetic cassettes, magnetic tape, magnetic disk storage, or other magnetic storage devices; or any other medium which can be used to store the desired content and which can be accessed by the computing device 10. Computing device may further comprise externally-accessible data ports or connections 12 such as serial ports, parallel ports, universal serial bus (USB) ports, and infrared ports and/or transmitter/receivers. Computing device may further comprise hardware for wireless communication with external devices such as IEEE 1394 (“Firewire”) interfaces, IEEE 802.11 wireless interfaces, BLUETOOTH® wireless interfaces, and so forth. Such ports and interfaces may be used to connect any number of external peripherals and accessories 60 such as visual displays, monitors, and touch-sensitive screens 61, USB solid state memory data storage drives (commonly known as “flash drives” or “thumb drives”) 63, printers 64, pointers and manipulators such as mice 65, keyboards 66, and other devices 67 such as joysticks and gaming pads, touchpads, additional displays and monitors, and external hard drives (whether solid state or disc-based), microphones, speakers, cameras, and optical scanners.

Processors 20 are logic circuitry capable of receiving programming instructions and processing (or executing) those instructions to perform computer operations such as retrieving data, storing data, and performing mathematical calculations. Processors 20 are not limited by the materials from which they are formed or the processing mechanisms employed therein, but are typically comprised of semiconductor materials into which many transistors are formed together into logic gates on a chip (i.e., an integrated circuit or IC). The term processor includes any device capable of receiving and processing instructions including, but not limited to, processors operating on the basis of quantum computing, optical computing, mechanical computing (e.g., using nanotechnology entities to transfer data), and so forth. Depending on configuration, computing device 10 may comprise more than one processor. For example, computing device 10 may comprise one or more central processing units (CPUs) 21, each of which itself has multiple processors or multiple processing cores, each capable of independently or semi-independently processing programming instructions based on technologies like complex instruction set computer (CISC) or reduced instruction set computer (RISC). Further, computing device 10 may comprise one or more specialized processors such as a graphics processing unit (GPU) 22 configured to accelerate processing of computer graphics and images via a large array of specialized processing cores arranged in parallel. Further computing device 10 may be comprised of one or more specialized processes such as Intelligent Processing Units, field-programmable gate arrays or application-specific integrated circuits for specific tasks or types of tasks. The term processor may further include: neural processing units (NPUs) or neural computing units optimized for machine learning and artificial intelligence workloads using specialized architectures and data paths; tensor processing units (TPUs) designed to efficiently perform matrix multiplication and convolution operations used heavily in neural networks and deep learning applications; application-specific integrated circuits (ASICs) implementing custom logic for domain-specific tasks; application-specific instruction set processors (ASIPs) with instruction sets tailored for particular applications; field-programmable gate arrays (FPGAs) providing reconfigurable logic fabric that can be customized for specific processing tasks; processors operating on emerging computing paradigms such as quantum computing, optical computing, mechanical computing (e.g., using nanotechnology entities to transfer data), and so forth. Depending on configuration, computing device 10 may comprise one or more of any of the above types of processors in order to efficiently handle a variety of general purpose and specialized computing tasks. The specific processor configuration may be selected based on performance, power, cost, or other design constraints relevant to the intended application of computing device 10.

System memory 30 is processor-accessible data storage in the form of volatile and/or nonvolatile memory. System memory 30 may be either or both of two types: non-volatile memory and volatile memory. Non-volatile memory 30a is not erased when power to the memory is removed, and includes memory types such as read only memory (ROM), electronically-erasable programmable memory (EEPROM), and rewritable solid state memory (commonly known as “flash memory”). Non-volatile memory 30a is typically used for long-term storage of a basic input/output system (BIOS) 31, containing the basic instructions, typically loaded during computer startup, for transfer of information between components within computing device, or a unified extensible firmware interface (UEFI), which is a modern replacement for BIOS that supports larger hard drives, faster boot times, more security features, and provides native support for graphics and mouse cursors. Non-volatile memory 30a may also be used to store firmware comprising a complete operating system 35 and applications 36 for operating computer-controlled devices. The firmware approach is often used for purpose-specific computer-controlled devices such as appliances and Internet-of-Things (IoT) devices where processing power and data storage space is limited. Volatile memory 30b is erased when power to the memory is removed and is typically used for short-term storage of data for processing. Volatile memory 30b includes memory types such as random-access memory (RAM), and is normally the primary operating memory into which the operating system 35, applications 36, program modules 37, and application data 38 are loaded for execution by processors 20. Volatile memory 30b is generally faster than non-volatile memory 30a due to its electrical characteristics and is directly accessible to processors 20 for processing of instructions and data storage and retrieval. Volatile memory 30b may comprise one or more smaller cache memories which operate at a higher clock speed and are typically placed on the same IC as the processors to improve performance.

There are several types of computer memory, each with its own characteristics and use cases. System memory 30 may be configured in one or more of the several types described herein, including high bandwidth memory (HBM) and advanced packaging technologies like chip-on-wafer-on-substrate (CoWoS). Static random access memory (SRAM) provides fast, low-latency memory used for cache memory in processors, but is more expensive and consumes more power compared to dynamic random access memory (DRAM). SRAM retains data as long as power is supplied. DRAM is the main memory in most computer systems and is slower than SRAM but cheaper and more dense. DRAM requires periodic refresh to retain data. NAND flash is a type of non-volatile memory used for storage in solid state drives (SSDs) and mobile devices and provides high density and lower cost per bit compared to DRAM with the trade-off of slower write speeds and limited write endurance. HBM is an emerging memory technology that provides high bandwidth and low power consumption which stacks multiple DRAM dies vertically, connected by through-silicon vias (TSVs). HBM offers much higher bandwidth (up to 1 TB/s) compared to traditional DRAM and may be used in high-performance graphics cards, AI accelerators, and edge computing devices. Advanced packaging and CoWoS are technologies that enable the integration of multiple chips or dies into a single package. CoWoS is a 2.5D packaging technology that interconnects multiple dies side-by-side on a silicon interposer and allows for higher bandwidth, lower latency, and reduced power consumption compared to traditional PCB-based packaging. This technology enables the integration of heterogeneous dies (e.g., CPU, GPU, HBM) in a single package and may be used in high-performance computing, AI accelerators, and edge computing devices.

Interfaces 40 may include, but are not limited to, storage media interfaces 41, network interfaces 42, display interfaces 43, and input/output interfaces 44. Storage media interface 41 provides the necessary hardware interface for loading data from non-volatile data storage devices 50 into system memory 30 and storage data from system memory 30 to non-volatile data storage device 50. Network interface 42 provides the necessary hardware interface for computing device 10 to communicate with remote computing devices 80 and cloud-based services 90 via one or more external communication devices 70. Display interface 43 allows for connection of displays 61, monitors, touchscreens, and other visual input/output devices. Display interface 43 may include a graphics card for processing graphics-intensive calculations and for handling demanding display requirements. Typically, a graphics card includes a graphics processing unit (GPU) and video RAM (VRAM) to accelerate display of graphics. In some high-performance computing systems, multiple GPUs may be connected using NVLink bridges, which provide high-bandwidth, low-latency interconnects between GPUs. NVLink bridges enable faster data transfer between GPUs, allowing for more efficient parallel processing and improved performance in applications such as machine learning, scientific simulations, and graphics rendering. One or more input/output (I/O) interfaces 44 provide the necessary support for communications between computing device 10 and any external peripherals and accessories 60. For wireless communications, the necessary radio-frequency hardware and firmware may be connected to I/O interface 44 or may be integrated into I/O interface 44. Network interface 42 may support various communication standards and protocols, such as Ethernet and Small Form-Factor Pluggable (SFP). Ethernet is a widely used wired networking technology that enables local area network (LAN) communication. Ethernet interfaces typically use RJ45 connectors and support data rates ranging from 10 Mbps to 100 Gbps, with common speeds being 100 Mbps, 1 Gbps, 10 Gbps, 25 Gbps, 40 Gbps, and 100 Gbps. Ethernet is known for its reliability, low latency, and cost-effectiveness, making it a popular choice for home, office, and data center networks. SFP is a compact, hot-pluggable transceiver used for both telecommunication and data communications applications. SFP interfaces provide a modular and flexible solution for connecting network devices, such as switches and routers, to fiber optic or copper networking cables. SFP transceivers support various data rates, ranging from 100 Mbps to 100 Gbps, and can be easily replaced or upgraded without the need to replace the entire network interface card. This modularity allows for network scalability and adaptability to different network requirements and fiber types, such as single-mode or multi-mode fiber.

Non-volatile data storage devices 50 are typically used for long-term storage of data. Data on non-volatile data storage devices 50 is not erased when power to the non-volatile data storage devices 50 is removed. Non-volatile data storage devices 50 may be implemented using any technology for non-volatile storage of content including, but not limited to, CD-ROM drives, digital versatile discs (DVD), or other optical disc storage; magnetic cassettes, magnetic tape, magnetic disc storage, or other magnetic storage devices; solid state memory technologies such as EEPROM or flash memory; or other memory technology or any other medium which can be used to store data without requiring power to retain the data after it is written. Non-volatile data storage devices 50 may be non-removable from computing device 10 as in the case of internal hard drives, removable from computing device 10 as in the case of external USB hard drives, or a combination thereof, but computing device will typically comprise one or more internal, non-removable hard drives using either magnetic disc or solid state memory technology. Non-volatile data storage devices 50 may be implemented using various technologies, including hard disk drives (HDDs) and solid-state drives (SSDs). HDDs use spinning magnetic platters and read/write heads to store and retrieve data, while SSDs use NAND flash memory. SSDs offer faster read/write speeds, lower latency, and better durability due to the lack of moving parts, while HDDs typically provide higher storage capacities and lower cost per gigabyte. NAND flash memory comes in different types, such as Single-Level Cell (SLC), Multi-Level Cell (MLC), Triple-Level Cell (TLC), and Quad-Level Cell (QLC), each with trade-offs between performance, endurance, and cost. Storage devices connect to the computing device 10 through various interfaces, such as SATA, NVMe, and PCIe. SATA is the traditional interface for HDDs and SATA SSDs, while NVMe (Non-Volatile Memory Express) is a newer, high-performance protocol designed for SSDs connected via PCIe. PCIe SSDs offer the highest performance due to the direct connection to the PCIe bus, bypassing the limitations of the SATA interface. Other storage form factors include M.2 SSDs, which are compact storage devices that connect directly to the motherboard using the M.2 slot, supporting both SATA and NVMe interfaces. Additionally, technologies like Intel Optane memory combine 3D XPoint technology with NAND flash to provide high-performance storage and caching solutions. Non-volatile data storage devices 50 may be non-removable from computing device 10, as in the case of internal hard drives, removable from computing device 10, as in the case of external USB hard drives, or a combination thereof. However, computing devices will typically comprise one or more internal, non-removable hard drives using either magnetic disc or solid-state memory technology. Non-volatile data storage devices 50 may store any type of data including, but not limited to, an operating system 51 for providing low-level and mid-level functionality of computing device 10, applications 52 for providing high-level functionality of computing device 10, program modules 53 such as containerized programs or applications, or other modular content or modular programming, application data 54, and databases 55 such as relational databases, non-relational databases, object oriented databases, NoSQL databases, vector databases, knowledge graph databases, key-value databases, document oriented data stores, and graph databases.

Applications (also known as computer software or software applications) are sets of programming instructions designed to perform specific tasks or provide specific functionality on a computer or other computing devices. Applications are typically written in high-level programming languages such as C, C++, Scala, Erlang, GoLang, Java, Scala, Rust, and Python, which are then either interpreted at runtime or compiled into low-level, binary, processor-executable instructions operable on processors 20. Applications may be containerized so that they can be run on any computer hardware running any known operating system. Containerization of computer software is a method of packaging and deploying applications along with their operating system dependencies into self-contained, isolated units known as containers. Containers provide a lightweight and consistent runtime environment that allows applications to run reliably across different computing environments, such as development, testing, and production systems facilitated by specifications such as containerd.

The memories and non-volatile data storage devices described herein do not include communication media. Communication media are means of transmission of information such as modulated electromagnetic waves or modulated data signals configured to transmit, not store, information. By way of example, and not limitation, communication media includes wired communications such as sound signals transmitted to a speaker via a speaker wire, and wireless communications such as acoustic waves, radio frequency (RF) transmissions, infrared emissions, and other wireless media.

External communication devices 70 are devices that facilitate communications between computing device and either remote computing devices 80, or cloud-based services 90, or both. External communication devices 70 include, but are not limited to, data modems 71 which facilitate data transmission between computing device and the Internet 75 via a common carrier such as a telephone company or internet service provider (ISP), routers 72 which facilitate data transmission between computing device and other devices, and switches 73 which provide direct data communications between devices on a network or optical transmitters (e.g., lasers). Here, modem 71 is shown connecting computing device 10 to both remote computing devices 80 and cloud-based services 90 via the Internet 75. While modem 71, router 72, and switch 73 are shown here as being connected to network interface 42, many different network configurations using external communication devices 70 are possible. Using external communication devices 70, networks may be configured as local area networks (LANs) for a single location, building, or campus, wide area networks (WANs) comprising data networks that extend over a larger geographical area, and virtual private networks (VPNs) which can be of any size but connect computers via encrypted communications over public networks such as the Internet 75. As just one exemplary network configuration, network interface 42 may be connected to switch 73 which is connected to router 72 which is connected to modem 71 which provides access for computing device 10 to the Internet 75. Further, any combination of wired 77 or wireless 76 communications between and among computing device 10, external communication devices 70, remote computing devices 80, and cloud-based services 90 may be used. Remote computing devices 80, for example, may communicate with computing device through a variety of communication channels 74 such as through switch 73 via a wired 77 connection, through router 72 via a wireless connection 76, or through modem 71 via the Internet 75. Furthermore, while not shown here, other hardware that is specifically designed for servers or networking functions may be employed. For example, secure socket layer (SSL) acceleration cards can be used to offload SSL encryption computations, and transmission control protocol/internet protocol (TCP/IP) offload hardware and/or packet classifiers on network interfaces 42 may be installed and used at server devices or intermediate networking equipment (e.g., for deep packet inspection).

In a networked environment, certain components of computing device 10 may be fully or partially implemented on remote computing devices 80 or cloud-based services 90. Data stored in non-volatile data storage device 50 may be received from, shared with, duplicated on, or offloaded to a non-volatile data storage device on one or more remote computing devices 80 or in a cloud computing service 92. Processing by processors 20 may be received from, shared with, duplicated on, or offloaded to processors of one or more remote computing devices 80 or in a distributed computing service 93. By way of example, data may reside on a cloud computing service 92, but may be usable or otherwise accessible for use by computing device 10. Also, certain processing subtasks may be sent to a microservice 91 for processing with the result being transmitted to computing device 10 for incorporation into a larger processing task. Also, while components and processes of the exemplary computing environment are illustrated herein as discrete units (e.g., OS 51 being stored on non-volatile data storage device 51 and loaded into system memory 35 for use) such processes and components may reside or be processed at various times in different components of computing device 10, remote computing devices 80, and/or cloud-based services 90. Also, certain processing subtasks may be sent to a microservice 91 for processing with the result being transmitted to computing device 10 for incorporation into a larger processing task. Infrastructure as Code (IaaC) tools like Terraform can be used to manage and provision computing resources across multiple cloud providers or hyperscalers. This allows for workload balancing based on factors such as cost, performance, and availability. For example, Terraform can be used to automatically provision and scale resources on AWS spot instances during periods of high demand, such as for surge rendering tasks, to take advantage of lower costs while maintaining the required performance levels. In the context of rendering, tools like Blender can be used for object rendering of specific elements, such as a car, bike, or house. These elements can be approximated and roughed in using techniques like bounding box approximation or low-poly modeling to reduce the computational resources required for initial rendering passes. The rendered elements can then be integrated into the larger scene or environment as needed, with the option to replace the approximated elements with higher-fidelity models as the rendering process progresses.

In an implementation, the disclosed systems and methods may utilize, at least in part, containerization techniques to execute one or more processes and/or steps disclosed herein. Containerization is a lightweight and efficient virtualization technique that allows you to package and run applications and their dependencies in isolated environments called containers. One of the most popular containerization platforms is containerd, which is widely used in software development and deployment. Containerization, particularly with open-source technologies like containerd and container orchestration systems like Kubernetes, is a common approach for deploying and managing applications. Containers are created from images, which are lightweight, standalone, and executable packages that include application code, libraries, dependencies, and runtime. Images are often built from a containerfile or similar, which contains instructions for assembling the image. Containerfiles are configuration files that specify how to build a container image. Systems like Kubernetes natively support containerd as a container runtime. They include commands for installing dependencies, copying files, setting environment variables, and defining runtime configurations. Container images can be stored in repositories, which can be public or private. Organizations often set up private registries for security and version control using tools such as Harbor, JFrog Artifactory and Bintray, GitLab Container Registry, or other container registries. Containers can communicate with each other and the external world through networking. Containerd provides a default network namespace, but can be used with custom network plugins. Containers within the same network can communicate using container names or IP addresses.

Remote computing devices 80 are any computing devices not part of computing device 10. Remote computing devices 80 include, but are not limited to, personal computers, server computers, thin clients, thick clients, personal digital assistants (PDAs), mobile telephones, watches, tablet computers, laptop computers, multiprocessor systems, microprocessor based systems, set-top boxes, programmable consumer electronics, video game machines, game consoles, portable or handheld gaming units, network terminals, desktop personal computers (PCs), minicomputers, mainframe computers, network nodes, virtual reality or augmented reality devices and wearables, and distributed or multi-processing computing environments. While remote computing devices 80 are shown for clarity as being separate from cloud-based services 90, cloud-based services 90 are implemented on collections of networked remote computing devices 80.

Cloud-based services 90 are Internet-accessible services implemented on collections of networked remote computing devices 80. Cloud-based services are typically accessed via application programming interfaces (APIs) which are software interfaces which provide access to computing services within the cloud-based service via API calls, which are pre-defined protocols for requesting a computing service and receiving the results of that computing service. While cloud-based services may comprise any type of computer processing or storage, three common categories of cloud-based services 90 are serverless logic apps, microservices 91, cloud computing services 92, and distributed computing services 93.

Microservices 91 are collections of small, loosely coupled, and independently deployable computing services. Each microservice represents a specific computing functionality and runs as a separate process or container. Microservices promote the decomposition of complex applications into smaller, manageable services that can be developed, deployed, and scaled independently. These services communicate with each other through well-defined application programming interfaces (APIs), typically using lightweight protocols like HTTP, protobuffers, gRPC or message queues such as Kafka. Microservices 91 can be combined to perform more complex or distributed processing tasks. In an embodiment, Kubernetes clusters with containerized resources are used for operational packaging of system.

Cloud computing services 92 are delivery of computing resources and services over the Internet 75 from a remote location. Cloud computing services 92 provide additional computer hardware and storage on as-needed or subscription basis. Cloud computing services 92 can provide large amounts of scalable data storage, access to sophisticated software and powerful server-based processing, or entire computing infrastructures and platforms. For example, cloud computing services can provide virtualized computing resources such as virtual machines, storage, and networks, platforms for developing, running, and managing applications without the complexity of infrastructure management, and complete software applications over public or private networks or the Internet on a subscription or alternative licensing basis, or consumption or ad-hoc marketplace basis, or combination thereof.

Distributed computing services 93 provide large-scale processing using multiple interconnected computers or nodes to solve computational problems or perform tasks collectively. In distributed computing, the processing and storage capabilities of multiple machines are leveraged to work together as a unified system. Distributed computing services are designed to address problems that cannot be efficiently solved by a single computer or that require large-scale computational power or support for highly dynamic compute, transport or storage resource variance or uncertainty over time requiring scaling up and down of constituent system resources. These services enable parallel processing, fault tolerance, and scalability by distributing tasks across multiple nodes.

Although described above as a physical device, computing device 10 can be a virtual computing device, in which case the functionality of the physical components herein described, such as processors 20, system memory 30, network interfaces 40, NVLink or other GPU-to-GPU high bandwidth communications links and other like components can be provided by computer-executable instructions. Such computer-executable instructions can execute on a single physical computing device, or can be distributed across multiple physical computing devices, including being distributed across multiple physical computing devices in a dynamic manner such that the specific, physical computing devices hosting such computer-executable instructions can dynamically change over time depending upon need and availability. In the situation where computing device 10 is a virtualized device, the underlying physical computing devices hosting such a virtualized computing device can, themselves, comprise physical components analogous to those described above, and operating in a like manner. Furthermore, virtual computing devices can be utilized in multiple layers with one virtual computing device executing within the construct of another virtual computing device. Thus, computing device 10 may be either a physical computing device or a virtualized computing device within which computer-executable instructions can be executed in a manner consistent with their execution by a physical computing device. Similarly, terms referring to physical components of the computing device, as utilized herein, mean either those physical components or virtualizations thereof performing the same or equivalent functions.

The skilled person will be aware of a range of possible modifications of the various aspects described above. Accordingly, the present invention is defined by the claims and their equivalents.

What is claimed is:

1. A computer system comprising a hardware memory, wherein the computer system is configured to execute software instructions stored on nontransitory machine-readable storage media that:
implement an adaptive compression and encryption pipeline using reinforcement learning for optimizing data processing efficiency while maintaining homomorphic encryption, comprising:
a data characterization processor that analyzes incoming data streams to extract statistical features, data type classifications, and estimated compression ratios achievable based on data entropy and redundancy patterns;
a reinforcement learning policy engine comprising trained neural networks that receive said statistical features and output pipeline configuration decisions;
a pipeline configuration controller that dynamically constructs and reconfigures a multi-stage compression pipeline based on said configuration decisions;
wherein said multi-stage compression pipeline performs a first compression stage comprising:
analyzing an input data stream to determine its statistical properties;
applying one or more transformations to the input data stream to increase compressibility and security;
producing a conditioned data stream and an error stream;
transforming the conditioned data stream into a dyadic distribution;
creating and managing a transformation matrix for reshaping the data distribution;
performing Huffman coding on the transformed data stream; and
combining the Huffman-encoded data stream with a secondary transformation data stream to produce a compressed and encrypted output stream;
a performance monitor that tracks compression ratios, processing latency, output quality metrics, and computational resource usage to generate reward signals for training said reinforcement learning policy engine;
wherein said reinforcement learning policy engine adaptively selects between one or more compression stages and determines compression parameters based on real-time performance feedback; and
wherein all operations are performed on encrypted data using fully homomorphic encryption without decryption.

2. The computer system of claim 1, wherein the reinforcement learning policy engine comprises a policy network that receives a state vector of at least 48 dimensions and outputs discretized configuration actions, a value network that estimates expected performance for state-action pairs, and an experience replay buffer that stores historical configuration decisions and outcomes for continuous policy improvement.

3. The computer system of claim 2, wherein the policy network determines the number of compression stages to implement between 1 and 5 stages, selects between traditional compression and variational autoencoder methods for each stage, and specifies compression ratio parameters between 0.1 and 1.0 and encryption depth parameters for homomorphic operations.

4. The computer system of claim 1, wherein the data characterization processor computes statistical measures including entropy and variance, extracts correlation coefficients for temporal pattern detection, and generates confidence scores for data type classification to form a comprehensive feature vector representing data stream characteristics.

5. The computer system of claim 1, wherein the pipeline configuration controller validates configuration feasibility before deployment, implements buffering mechanisms to ensure smooth transitions between configurations without stream interruption, and maintains rollback capability to restore previous configurations when performance degradation is detected.

6. The computer system of claim 1, wherein the performance monitor calculates a multi-objective reward function that balances compression ratio achievement against output quality preservation while penalizing excessive computational cost and processing latency, with an additional stability bonus when reconfiguration is not required.

7. The computer system of claim 1, wherein upon selection by the reinforcement learning policy engine, a second compression stage processes the first stage output using a variational autoencoder trained with a constrained loss function that encourages latent space variables to follow a nearly dyadic distribution while adding an additional homomorphic encryption layer.

8. The computer system of claim 7, wherein the variational autoencoder training employs a joint loss function combining reconstruction accuracy measurement with distribution divergence penalties and regularization terms, using carefully tuned weighting parameters to achieve both high compression efficiency and adherence to the target dyadic distribution.

9. The computer system of claim 1, further comprising an adaptive training subsystem that continuously collects state-action-reward trajectories from production operations and performs periodic policy updates using Proximal Policy Optimization while implementing safe exploration strategies that maintain performance within acceptable bounds.

10. The computer system of claim 1, wherein dynamic reconfiguration occurs when the performance monitor detects output quality degradation exceeding 5% from baseline quality metrics, processing latency increases beyond system-defined timeout values, or statistical analysis reveals data distribution shifts exceeding predefined variance thresholds.

11. A method for adaptive compression and encryption using reinforcement learning, comprising:
implementing an adaptive compression and encryption pipeline using reinforcement learning for optimizing data processing efficiency while maintaining homomorphic encryption, comprising:
analyzing incoming data streams with a data characterization processor to extract statistical features, data type classifications, and estimated compression ratios achievable based on data entropy and redundancy patterns;
receiving said statistical features at a reinforcement learning policy engine comprising trained neural networks and outputting pipeline configuration decisions;
dynamically constructing and reconfiguring a multi-stage compression pipeline with a pipeline configuration controller based on said configuration decisions;
wherein said multi-stage compression pipeline performs a first compression stage comprising: analyzing an input data stream to determine its statistical properties;
applying one or more transformations to the input data stream to increase compressibility and security;
producing a conditioned data stream and an error stream;
transforming the conditioned data stream into a dyadic distribution;
creating and managing a transformation matrix for reshaping the data distribution;
performing Huffman coding on the transformed data stream; and
combining the Huffman-encoded data stream with a secondary transformation data stream to produce a compressed and encrypted output stream; tracking compression ratios, processing latency, output quality metrics, and computational resource usage with a performance monitor to generate reward signals for training said reinforcement learning policy engine;
wherein said reinforcement learning policy engine adaptively selects between one or more compression stages and determines compression parameters based on real-time performance feedback; and
wherein all operations are performed on encrypted data using fully homomorphic encryption without decryption.

12. The method of claim 11, wherein the reinforcement learning policy engine comprises a policy network that receives a state vector of at least 48 dimensions and outputs discretized configuration actions, a value network that estimates expected performance for state-action pairs, and an experience replay buffer that stores historical configuration decisions and outcomes for continuous policy improvement.

13. The method of claim 12, wherein the policy network determines the number of compression stages to implement between 1 and 5 stages, selects between traditional compression and variational autoencoder methods for each stage, and specifies compression ratio parameters between 0.1 and 1.0 and encryption depth parameters for homomorphic operations.

14. The method of claim 11, wherein the data characterization processor computes statistical measures including entropy and variance, extracts correlation coefficients for temporal pattern detection, and generates confidence scores for data type classification to form a comprehensive feature vector representing data stream characteristics.

15. The method of claim 11, wherein the pipeline configuration controller validates configuration feasibility before deployment, implements buffering mechanisms to ensure smooth transitions between configurations without stream interruption, and maintains rollback capability to restore previous configurations when performance degradation is detected.

16. The method of claim 11, wherein the performance monitor calculates a multi-objective reward function that balances compression ratio achievement against output quality preservation while penalizing excessive computational cost and processing latency, with an additional stability bonus when reconfiguration is not required.

17. The method of claim 11, wherein upon selection by the reinforcement learning policy engine, a second compression stage processes the first stage output using a variational autoencoder trained with a constrained loss function that encourages latent space variables to follow a nearly dyadic distribution while adding an additional homomorphic encryption layer.

18. The method of claim 17, wherein the variational autoencoder training employs a joint loss function combining reconstruction accuracy measurement with distribution divergence penalties and regularization terms, using carefully tuned weighting parameters to achieve both high compression efficiency and adherence to the target dyadic distribution.

19. The method of claim 11, further comprising continuously collecting state-action-reward trajectories from production operations with an adaptive training subsystem and performing periodic policy updates using Proximal Policy Optimization while implementing safe exploration strategies that maintain performance within acceptable bounds.

20. The method of claim 11, wherein dynamic reconfiguration occurs when the performance monitor detects output quality degradation exceeding 5% from baseline quality metrics, processing latency increases beyond system-defined timeout values, or statistical analysis reveals data distribution shifts exceeding predefined variance thresholds.
